(19) United States
(12) Patent Application Publication
(10) Pub. No.: US 2007/0063849 A1
(43) Pub. Date: Mar. 22, 2007

(54) Wearable haptic telecommunication device and system

(76) Inventors: Francesca Rosella, Rome (IT); Ryan T. Genz, Stockholm, ME (US)

Correspondence Address: JAMES E. EAKIN, P.O. BOX 1250, MENLO PARK, CA, 94025-4317, US

(21) Appl. No.: 11/515,690

(22) Filed: Sep. 5, 2006

Related U.S. Application Data
(60) Provisional application No. 60/714,094, filed on Sep. 2, 2005.

(51) Int. Cl. G08B 23/00

(52) U.S. Cl. 340/573.1

(57) ABSTRACT

A wearable telecommunication device such as a garment that allows sending the sensation of touch, for example in the form of a hug, over a distance. Embedded in the garment are sensors and actuators, and typically one garment is worn by the sender and another by the recipient. The sensors capture various parameters representative of the touch, including the strength of the touch, the skin warmth and the heartbeat rate of the wearer, and the actuators recreate the sensation of that touch, and warmth through heating, vibration, and inflation. A wired or wireless connection permits the data captured by the sensors in the sender garment to be transmitted to the actuators in the recipient garment.

### FIELD OF THE INVENTION

This invention relates generally to wearable telecommunication devices, and more particularly relates to sensing and transmission of haptic feedback via telecommunications or other networks as a means for communicating emotion, touch or other sensory experiences over distance. The invention is particularly adapted to forms of technology that are wearable in the shape of a garment or a series of garments.

### BACKGROUND OF THE INVENTION

Garments historically have been worn for decoration, warmth, status, modesty and similar purposes. Human contact, for example, a hug, has, historically, been limited to face-to-face interaction.

In many circumstances, there has been a need for devices which could convey human contact without the requirement of the humans being in immediate proximity to one another. Thus, in certain medical applications, it is useful to provide a sense of human contact without requiring direct physical contact. In addition, in various training exercises, for example in military contexts, there are advantages to conveying a sense of physical contact without requiring a one-to-one ratio between trainer and trainee.

As a result, there has been a long-felt need for devices which can detect, encode, transmit and reproduce sensory events over a distance.

### SUMMARY OF THE INVENTION

The present invention is directed to methods, techniques, systems and devices for transmitting sensory events from one person to another over a distance. Stated more generally, the present invention is directed to a haptic telecommunication system and device that allows new methods of telecommunication by transmitting non-verbal aspects of communication over distance. The present invention is directed to being able to encode, transmit over distance and render haptically physical sensory events using sensors, actuators, microprocessors and telecommunication networks. For clarity of illustration, the invention will be described through illustration of how a hug may be transmitted, although it will be appreciated by those skilled in the art that the present invention may also be used to communicate other sensory events to a recipient. For example, the present invention can be used as a training device for, for example, teaching dancing, aside from the medical, military and related applications discussed previously.

The present invention includes as one of its aspects the discovery that certain sensory events, again, for example, a hug, can be encoded and transmitted as data.

Another aspect of the invention is that certain sensory events, such as hugs, once encoded as data, can be transmitted and effectively rendered to a person located remotely, either in the next room or far away.

It is another discovery of the present invention that inflatable actuators, appropriately controlled by a microprocessor and placed within a housing such as a garment, can effectively provide the sensation of touch to a recipient, typically by constriction or similar action. For convenience, because a hug will be used to illustrate the invention, an appropriate garment for the illustration of the invention is a shirt.

A form of the invention is directed generally to consumer telecommunication.

In another form the invention is useful for controlling remotely household appliances.

In another form of the invention the sensors and actuators will allow for bio-data monitoring and sharing with remote medical personnel, databases or family members.

A form of the invention is also directed generally to medical rehabilitation.

Still another form of the invention is useful in applications such as assistive learning tool, maintaining of normal interaction standards while in orbital space.

### THE FIGURES

FIG. 1A shows a system diagram, where the Hug Shirts communicate with their respective mobile phones via Bluetooth, and the phones communicate with each other by exchanging hug data contained in SMS messages. It will be appreciated that the use of the Bluetooth is exemplary only and is only one possible communications protocol.

FIG. 1B illustrates a shirt such as may be used with the invention, including a variety of generally circular markings to indicate possible placement of the actuators and sensors used in an exemplary arrangement of the invention.

FIG. 2 is a more detailed view of an implementation of the controller logic of the present invention, again illustrating use of the present invention to send and receive a hug. The controller board gathers data from the sensor packages of the sending shirts, and provides it to the receiving shirt over a suitable communications link using, for example, Bluetooth or other communications protocols. The data, after receipt by the second shirt, is then processed by the controller in the recipient shirt and communicated to the receiving shirt's array of actuators and other devices.

FIG. 3 illustrates schematically the actuator and sensor package denominated herein as a “sandwich” as shown in FIG. 2. The sandwich contains the sensors which collect the hug data and the actuators that recreate the sensory event. For example, for a hug, the sensors may be carbon foam, strain gauge, and so on, and on the recipient side the hug may be reproduced simply by the use of a few inflatable bladders. However, it will be readily understood that the sensor arrangement shown in FIG. 3 may include thermal, heart rate, humidity, wind chill or other sensors, with appropriate actuators on the receive side. The sensors may be implemented as thermistors, microphones, or other suitable devices for monitoring the desired characteristics of the sender. It will also be appreciated that each shirt will typically have an identical arrangement, so that the sending shirt may also serve as the receiving shirt, and vice versa.

FIG. 4 is a flow chart showing a pseudo code representation of the program steps by which the mobile phone begins its hug recording process, receives the data from the Hug Shirt sensors, and transmits the hug data via SMS from the mobile phone.

FIG. 5 is a flow chart showing a pseudo code representation of the program steps by which the Hug Shirt microprocessor begins recording, finishes recording and transmits the recorded hug data to the mobile phone.

FIG. 6 is a flow chart showing a pseudo code representation of the program steps by which the mobile phone receives hug data from SMS, communicates with the Hug Shirt microprocessor and finally transmits hug data to the Hug Shirt.

FIG. 7 is a flow chart showing a pseudo code representation of the program steps by which the Hug Shirt microprocessor receives the hug data from the mobile phone, and converts it to the haptic actuator output.

### DETAILED DESCRIPTION OF THE INVENTION

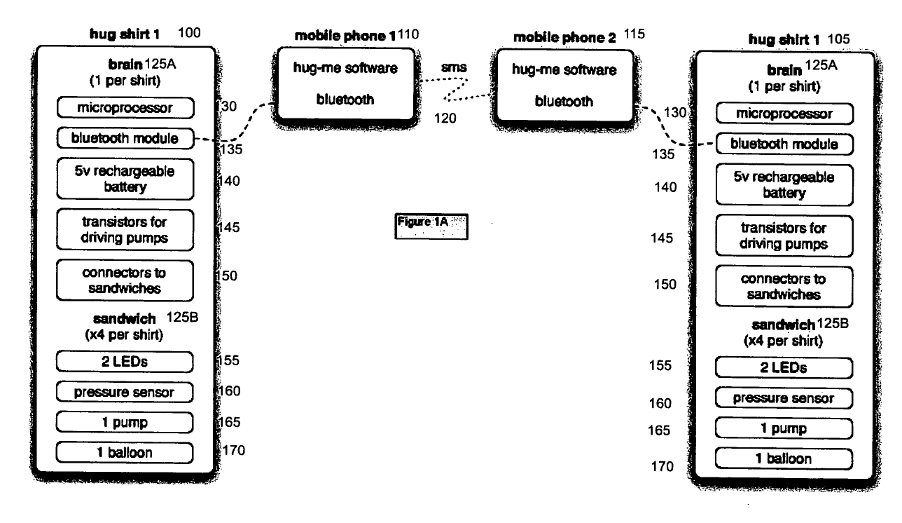

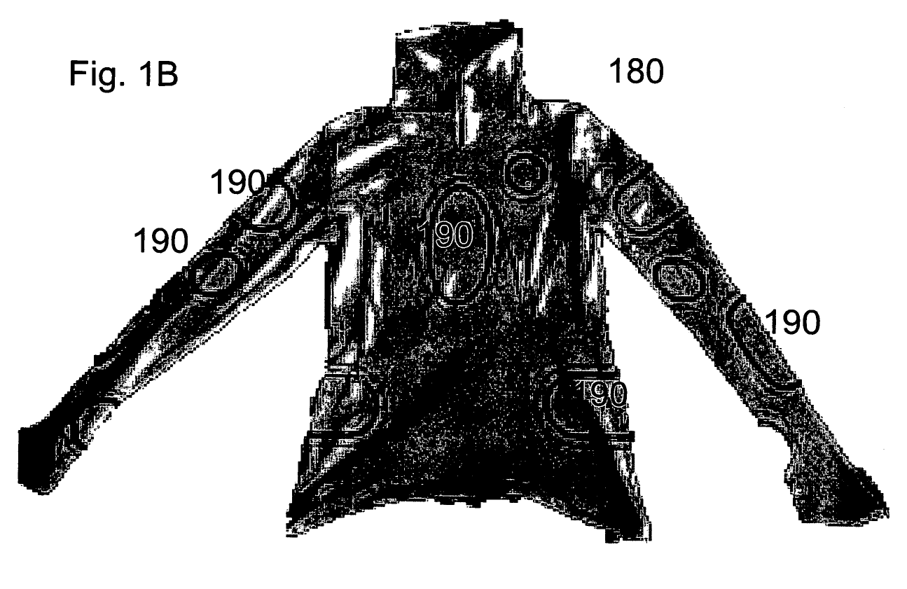

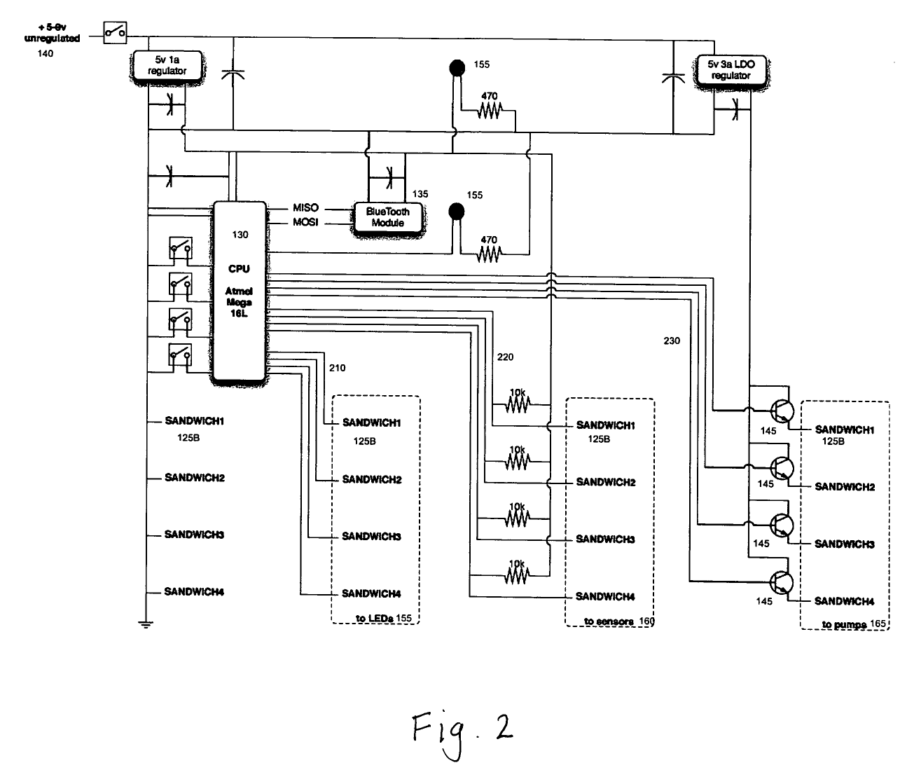

Reference is first made to FIGS. 1A and 2 in which a schematic system diagram of an exemplary arrangement of the present invention is shown.

In an embodiment, operation involves two substantially identical Hug Shirts 100 and 105 and two mobile phones 110 and 115 or other wireless devices capable of data communication. Each hug shirt 100 and 105 typically, although not necessarily, comprises a brain 125A and one or more sandwiches 125B. In at least some embodiments, the brain 125A comprises at least one microprocessor 130, as well as a communications module which may either be wired or wireless and may, for example, use the Bluetooth or other wireless protocol. The brain 125A can also include a power source 140, such as a five volt rechargeable battery, together with actuator electronics for driving portions of the sandwich 125B, typically one or more pumps 165. The brain 125A typically also includes the appropriate connections to the one or more sandwiches 125B.

The sandwiches 125B, a plurality of which are shown in FIG. 2, are typically positioned at selected locations around the hug shirt 100 as discussed hereinafter, and can, in at least one embodiment, comprise at least one LED 155, although an LED is not required for all embodiments, together with at least one pressure sensor 160 which communicates with the microprocessor 130 in the associated brain 125A. The sandwich also includes at least one pump 165, which fills or deflates a balloon or other bladder 170 in accordance with instructions from the brain 125A.

A user wearing a hug shirt 100 initiates a hug, or other appropriate physical movement. The movement of the user within the shirt 100 presses on various sensors 160 contained in the sandwiches 125B such that the pressure of the hug is recorded and encoded into digital data by the processor 130. This data is then transmitted to the mobile phone 110 through Bluetooth or other link 135. Once in the phone 110 the data is then packaged into an SMS and sent through the mobile phone network to the another person's (the recipient) phone, e.g., phone 115. The recipient may be thousand of miles away but will receive the SMS as long as they have mobile phone network coverage. The recipient's phone then transfers the data contained in the SMS via Bluetooth to their own hug shirt, where the data activates the actuators 145 to cause the pumps 165 to inflate the appropriate balloons 170 in the amounts determined by the sender's pressure sensors, recreating the hug that the sender recorded and sent. It will be appreciated from FIG. 2 that the microprocessor or CPU 130 provides control signals to the LEDs 155 in the various sandwiches along lines 210, receives input from the sensors 160 along lines 220, and controls the actuators 145 to drive the pumps along lines 230.

As shown in FIG. 1B, the Hug Shirt 100 looks like a standard long sleeve shirt 180. The sandwich packages are very thin and are able to be placed inside the shirt in pockets or via adhesive material, for example at the locations indicated by the circular areas 190. The shirt can be worn comfortably. The sandwich packages are positioned in strategic points (around the neck, shoulders, hips, and back) in order to recreate a physical natural sensation when receiving the hug and allowing for natural interface use when sending the hug. The modularity of the sandwich makes it affordable to organize in a variety of configurations, and makes it also easy to remove from clothing for cleaning or storage.

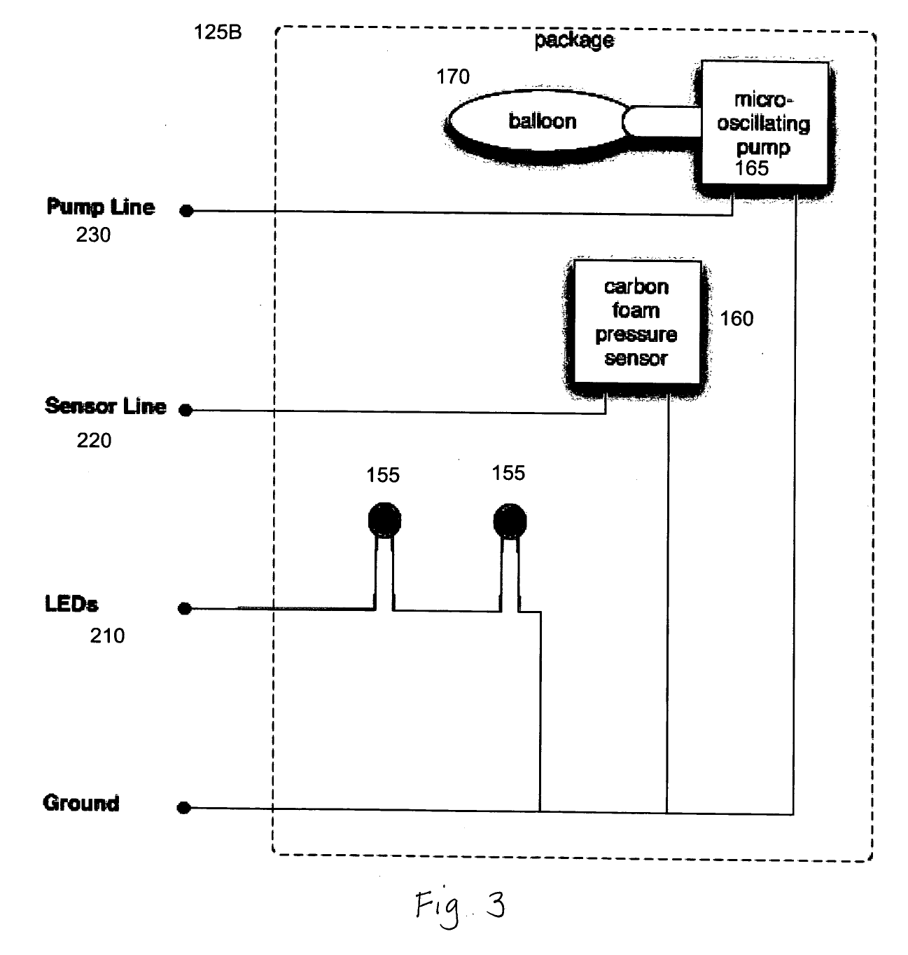

The exemplary arrangement shown in FIG. 3, relates to the sandwich package showing the components within contained. In at least some embodiments, the sandwich comprises sensors and actuators. In one embodiment, the sensors included in the sandwich package are, for example, one or more of the following: pressure sensor, heart beat rate sensor, temperature sensor, and a microphone. In one embodiment, the actuators included in the sandwich package are, for example, one or more of: a speaker, a heating pad, and a tiny pump and a balloon or other bladder.

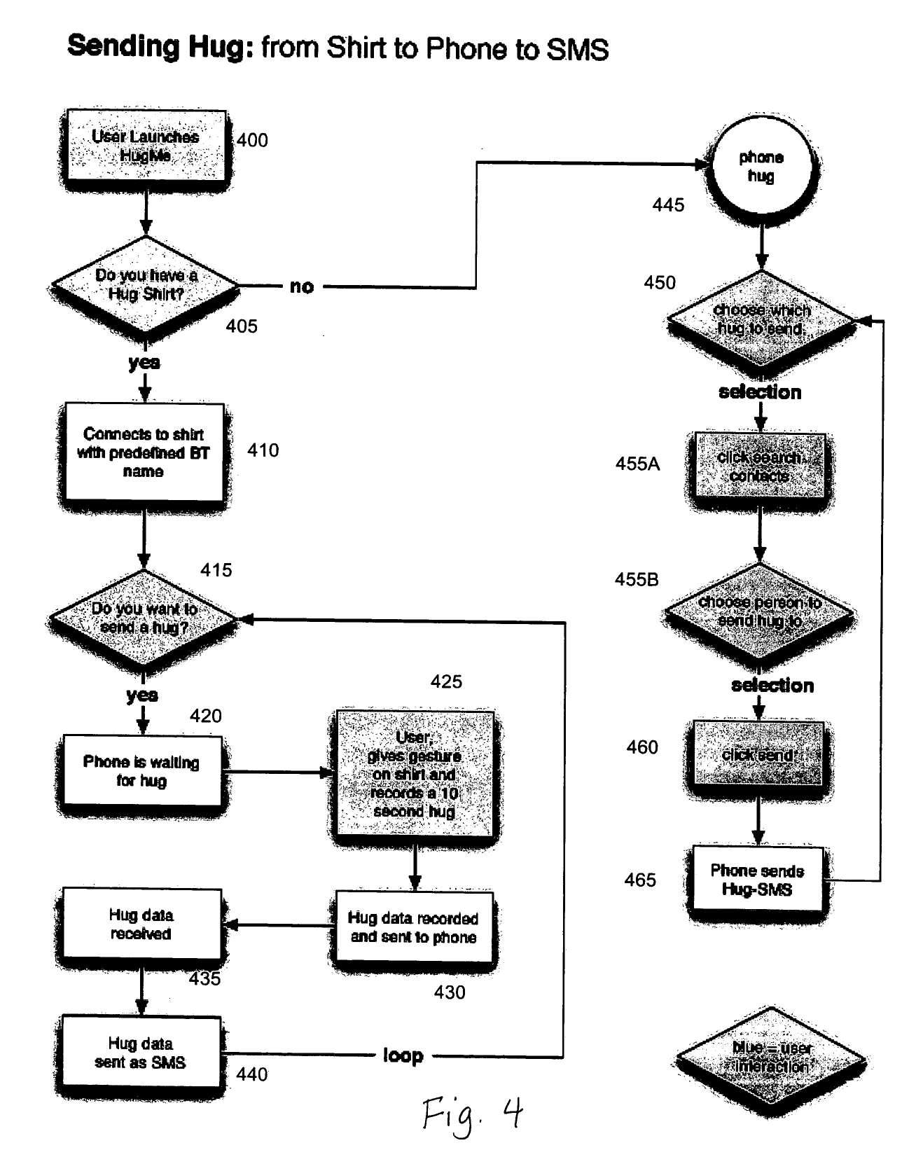

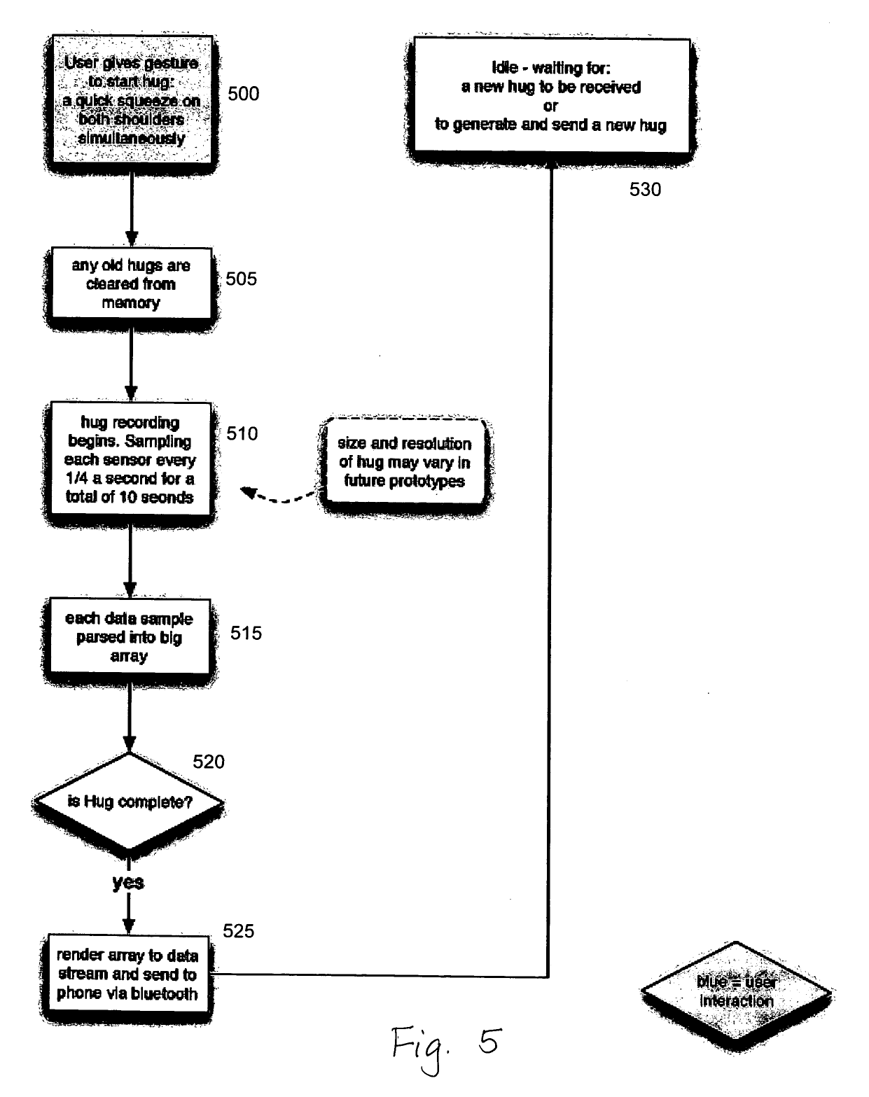

The flow chart shown in FIGS. 4 and 5, relates to the operation of the Hug Shirt. FIG. 4 illustrates in pseudo-code form the program steps by which the mobile phone begins its hug recording process, receives the data from the Hug Shirt sensors, and transmits the hug data via SMS from the mobile phone. FIG. 5 illustrates a pseudo code representation of the program steps by which the Hug Shirt microprocessor begins recording, finishes recording and transmits the recorded hug data to the mobile phone or other wired or wireless communications device. A mobile phone is described herein for simplicity. In general, this is accomplished as follows: when sending a hug the user touches the pressure sensors located in the Hug Shirt, activating the heart beat sensor, the temperature sensor, and the pressure sensor itself. The sensors sense the heart beat rate, skin temperature and strength of the user's hug. The hug data reaches the microcontroller and is then transmitted over the Bluetooth connection to the user's mobile phone.

More particularly, when the hug shirt 100 is actuated by movement of the wearer, a HugMe process, for example, is initiated at step 400. The process determines that a hug shirt is being worn at step 405, and initiates communication between the wireless device, such as a Bluetooth or other similar device at step 410, and the microprocessor in shirt. If the wearer wants to send a hug (or other similar gesture since a hug is only exemplary), step 415, the phone is placed in ‘wait’ mode at step 420 while the user makes the appropriate gesture within the shirt at step 425. For example, this can be done by maintaining the hug or other gesture long enough to allow recordation of the sensor data. In some embodiments the data recording process takes a few seconds, although the length of time required to record a gesture will vary with the implementation of the sensors, microprocessor and related equipment in a given embodiment and, accordingly, may take more or less time.

Once the hug data is recorded, steps 430 and 435, the hug data is converted to a messaging format, for example SMS, and sent at step 440 to the recipient who is, for example, located remotely. For some embodiments, remote may simply be across a room or within a facility, although in other embodiments, remote may mean great distances or any distance. The process then loops to step 415, to permit further hugs or other gestures to be sent.

In a related aspect of the present invention, if the user of the HugMe software is not wearing a shirt, but still wishes to convey a hug to a recipient, the software shown in FIG. 4 will allow the user to connect to the system, step 445, choose a hug at step 450, search and select the person to whom to send the hug at 455A-B, and then send the hug at steps 460 and 465 via a suitable telecommunications system, again, for example, via SMS or other techniques. It will be appreciated that, similarly, the recipient need not be immediately available to receive the hug, and instead the hug may be stored at the recipient's end, and conveyed when the recipient next dons the hug shirt.

Referring particularly to FIG. 5, the steps by which the microprocessor records a gesture such as a hug. At 500 the process starts in response to a user actuation, such as, for example, a movement or a specific gesture such as a quick squeeze on both shoulders simultaneously. This clears old hugs from memory, step 505, and hug recording begins, step 510, by sampling each sensor for an appropriate period. Each of the data samples is then parsed and stored, step 515, such that an array of data representing the hug is formed. Once the hug is complete, 520, the array of data is rendered for transmission as a data stream, step 525. The processor then returns to an idle state at 530.

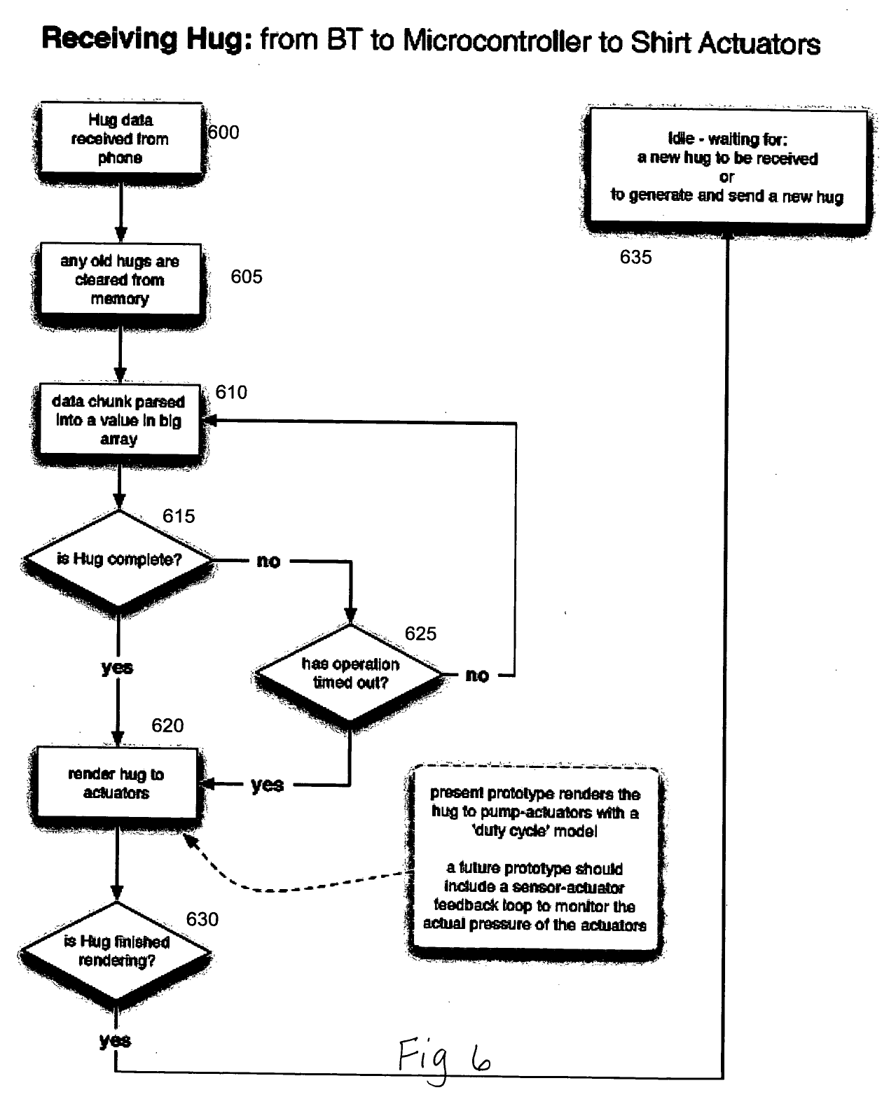

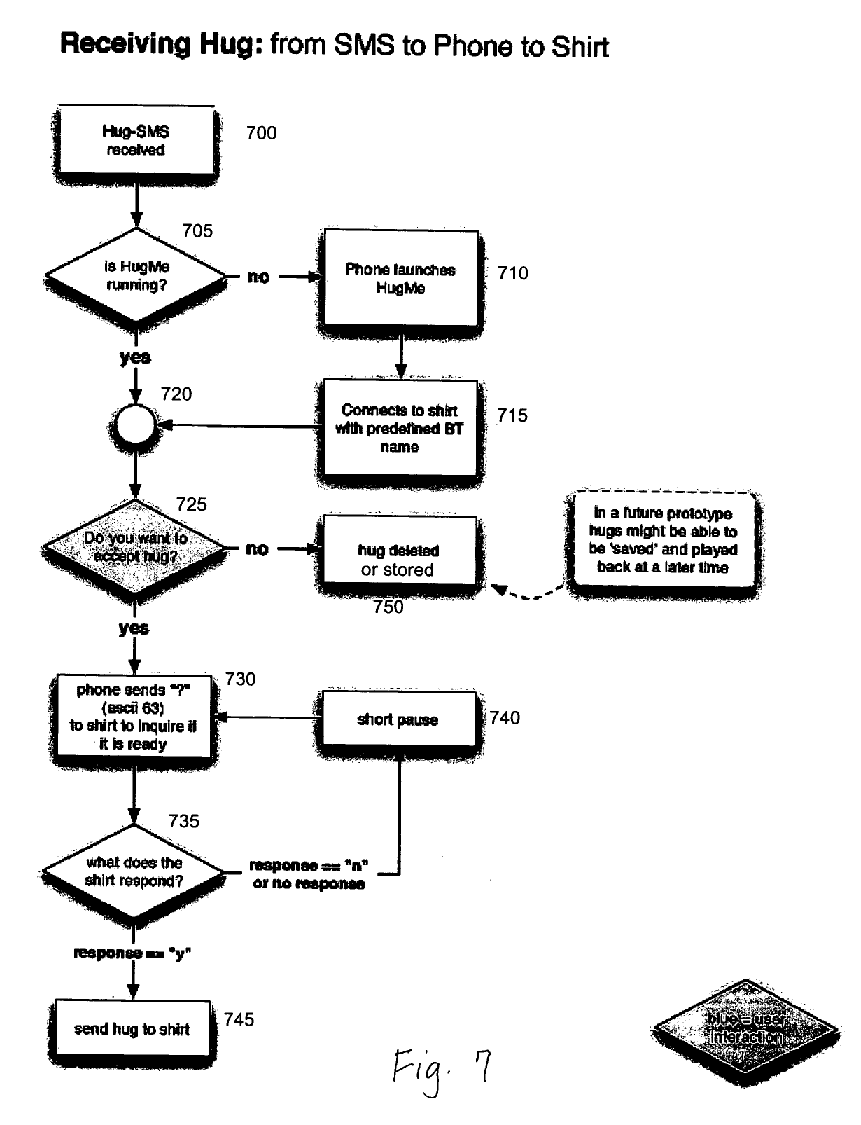

The flow chart shown in FIGS. 6 and 7 shows how the hug SMS is received by the recipient user. Generally, in the recipient shirt the microcontroller receives the hug data from the SMS via Bluetooth and starts the actuators. The actuators convert the hug data into heart beat sound from the speaker, pressure through inflation and deflation of the balloon operated by the pump, and warmth through the heating pad, which warms up at the sender skin temperature. As shown in FIG. 6, which is a pseudo code representation of the program steps by which the mobile phone receives hug data from SMS, communicates with the Hug Shirt microprocessor and finally transmits hug data to the Hug Shirt, the process starts at 600 when hug data is received from the phone or other communications device. The microprocessor clears old hugs from memory, step 605, and the incoming data stream is parsed into a data array, step 610. Once the reassembly of the hug data is complete, step 615, the hug is rendered by being transmitted to the various actuators, step 620, unless a failure has occurred, such as can be determined by timing out, step 625. If the hug has finished rendering, 630, the processor returns to idle at step 635.

FIG. 7 is a flow chart showing a pseudo code representation of the program steps by which the Hug Shirt microprocessor receives the hug data from the mobile phone, and converts it to the haptic actuator output. At 700 the process starts, and determines if the HugMe process is running, 705. If not, the processor causes the process to launch, 710, and connects at 715 to the shirt with the predefined name of the recipient, such as a Bluetooth device name. The Yes/No sequence converges at step 720, and the recipient is asked whether they wish to receive the hug or other gesture, step 725, and if so the phone or other device 115 determines whether the shirt is ready to receive, step 730. If the shirt is not ready, as determined at step 735, a pause is imposed at 740 and the inquiry is repeated. If the shirt is ready, step 745, the hug is sent to the shirt for processing as discussed in connection with FIG. 6. If the user does not wish to receive the hug at step 725, the hug may be either deleted or saved for future receipt or other processing, step 750.

The same operations shown in the flow chart from FIG. 4 to FIG. 7 can be repeated infinite times in a bi-directional exchange between two users, and/or multidirectional exchange from one user to many or from many users to one.

Having fully described a preferred embodiment of the invention and various alternatives, those skilled in the art will recognize, given the teachings herein, that numerous alternatives and equivalents exist which do not depart from the invention. It is therefore intended that the invention not be limited by the foregoing description, but only by the appended claims.

We claim:

1. A garment configured to convey haptic information comprising
at least one sensor,
a microprocessor for receiving inputs from the at least one sensor,
at least one pump responsive to the microprocessor,
at least one bladder responsive to the pump, and
a communications link for transmitting data received from the microprocessor.

2. The garment of claim 1 further comprising a communications link for receiving data from another garment.
